(19) United States
(12) Patent Application Publication
(10) Pub. No.: US 2014/0300232 A1
(43) Pub. Date: Oct. 9, 2014

(54) HIGH ACCELERATION ROTARY ACTUATOR

(71) Applicant: Gerald K. Langreck, Phillips, WI (US)

(72) Inventor: Gerald K. Langreck, Phillips, WI (US)

(21) Appl. No.: 14/200,314

(22) Filed: Mar. 7, 2014

Related U.S. Application Data
(60) Provisional application No. 61/851,447, filed on Mar. 8, 2013.

(51) Int. Cl. H02K 1/27

(52) U.S. Cl. CPC H02K 1/2706
USPC 310/156.01

(57) ABSTRACT

A rotary actuator having a tandem rotor, a first magnetic element, a second magnetic element and a tandem stator is disclosed.

### TECHNICAL FIELD OF THE INVENTION

The invention is in the general field of servo systems. The invention involves 4 phase tandem rotor and tandem stator servo motors. Both permanent magnet and reluctance versions with combinations of permanent magnet and reluctance servo motors are given.

### BACKGROUND OF PRIOR ART

There are many automation companies advertising their servo system superior qualities and capabilities. Specifications are given to describe the servo motor and drive qualities and capabilities. General specifications are given such as high efficiency designs, superior power density and torque density designs, smooth ripple free torque operation designs, high speed designs, and low inertia designs or high torque to inertia ratio designs giving superior acceleration and deceleration operation. Numerical specifications are given such as motor dimensional size, power output and heat dissipation, rated speed and maximum speed, continuous torque and peak torque, rated current and peak current, and rotor moment of inertia.

### SUMMARY OF THE ADVANTAGES OF THE INVENTION

It is an objective of the invention to substantially increase the above desired qualities and capabilities. The invention especially provides designs with a low inertia rotor resulting in a high torque to inertia ratio servo motor that at the same time results in a very high torque servo motor in a small package. Also the invention provides novel electronic current driving methods that permits the realization of high torque to inertia ratio servo motor designs for servo control. The invention does not require tying phase terminals together providing a neutral point. Tying the phase terminals together restricts the realization of the optimum current waveforms and also defeats the electrical isolation of the phases. Reluctance versions have better constant power characteristics at high speeds than the permanent magnet versions. Combinations of reluctance and permanent magnet rotors give combinations of both types which allow meeting various applications criteria for optimization. Very fast transients of speed change can take advantage of the energy storage capability of the reluctance magnetizing component of the rotor. Also extra inductance can be added to the permanent magnet component for energy storage capability to facilitate very fast speed transients. This energy storage capability can be utilized in single step transients or multiple cycle transients. Further detailed descriptions of how to make a rotary servo motor or actuator resulting in a very high torque and high torque to inertia ratio servo system is given below.

### DESRIPTION OF THE INVENTION

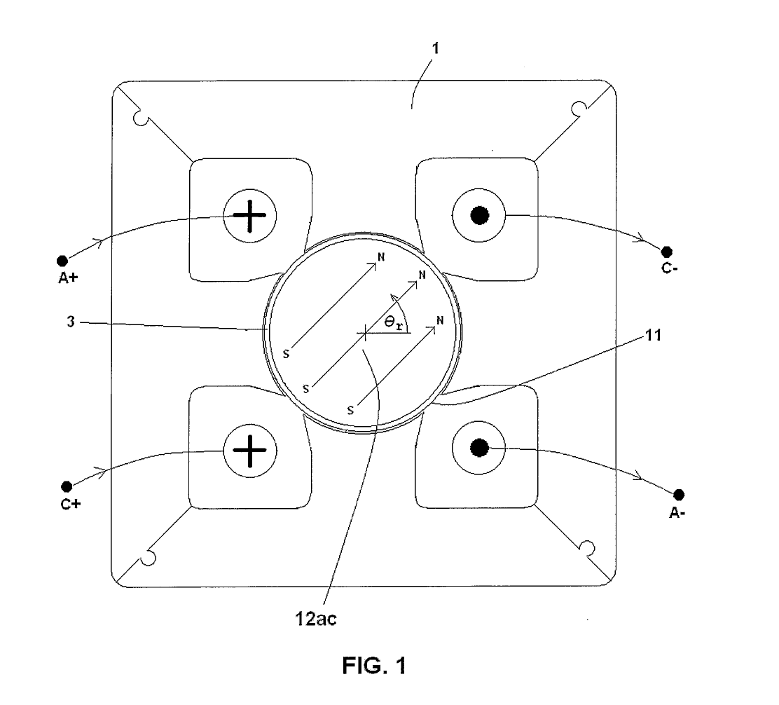

FIG. 1 shows the A phase and C phase tandem motor element 1 of a 4 phase motor. This element contains the tandem rotor 11. A rod shaped permanent magnet 12ac with a north pole and south pole is mounted in rotor tube or sleeve 3. The square stator lamination stack holds the 2 windings. The windings are each two poles with terminal leads marked A+ and A− and C+ and C− with current indicating direction arrows on the leads of the phases.

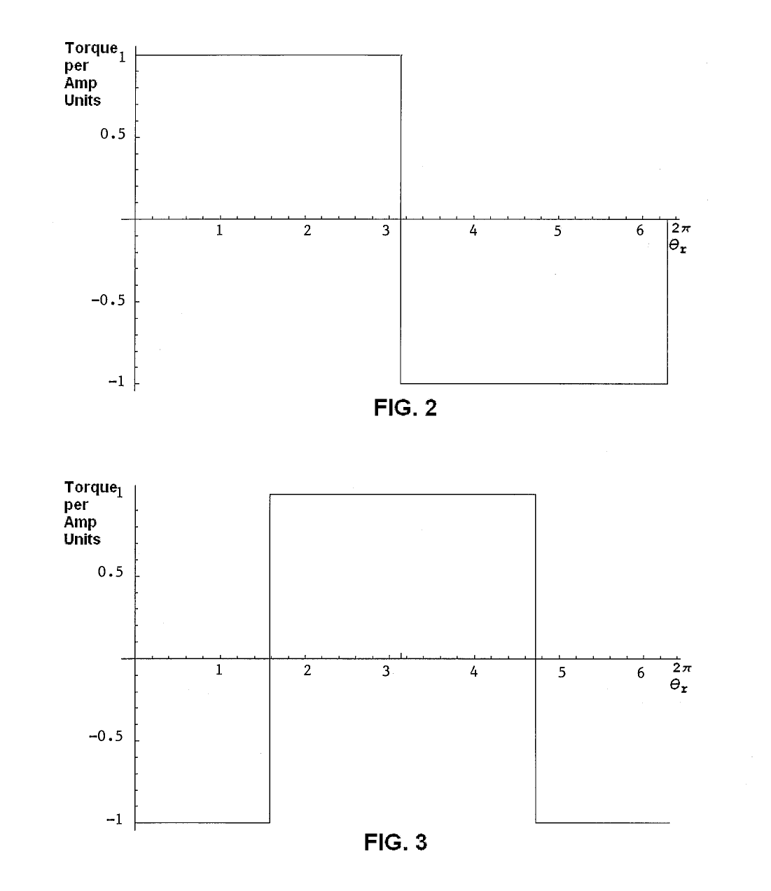

FIG. 2 is a graph of the torque per amp versus rotor angle, θₓ, for one revolution of the tandem rotor 11 for A phase. Note with two magnetic poles the torque per amp goes through one revolution for a full 360 degrees to produce an approximate square wave torque per amp output as shown in FIG. 2.

FIG. 3 is a graph of the torque per amp versus rotor angle, θₓ, for one revolution of the tandem rotor 11 for C phase. Note with two magnetic poles the torque per amp goes through one revolution for a full 360 degrees to produce an approximate square wave torque per amp output as shown. Note C phase lags A phase by 90 degrees for the direction of θₓ as shown in FIG. 3.

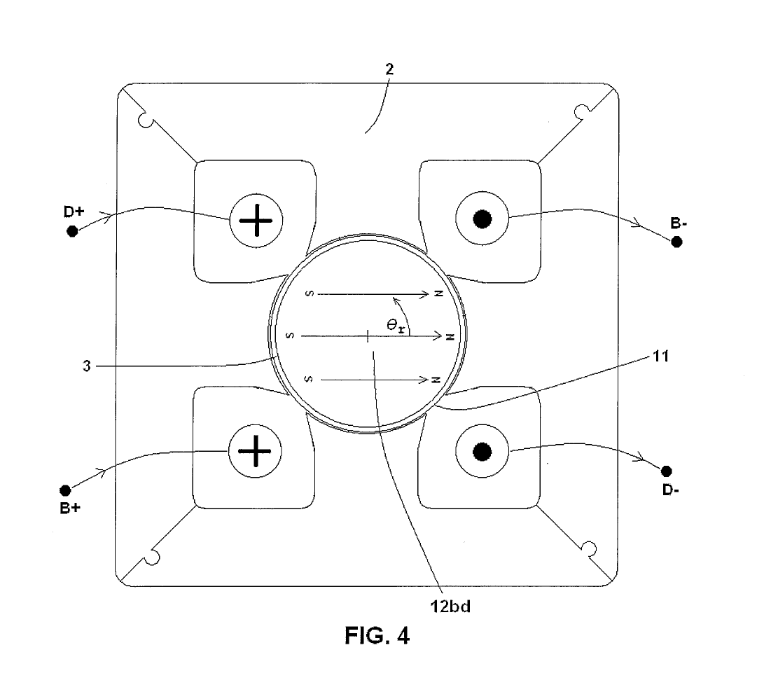

FIG. 4 shows the B phase and D phase tandem motor element 2 of a 4 phase motor. This element contains the tandem rotor 11. A rod shaped permanent magnet 12bd with a north pole and south pole is mounted in rotor tube or sleeve 3. The square stator lamination stack holds the 2 windings. The windings are each two poles with terminal leads marked B+ and B− and D+ and D− with current indicating direction arrows on the leads of the phases.

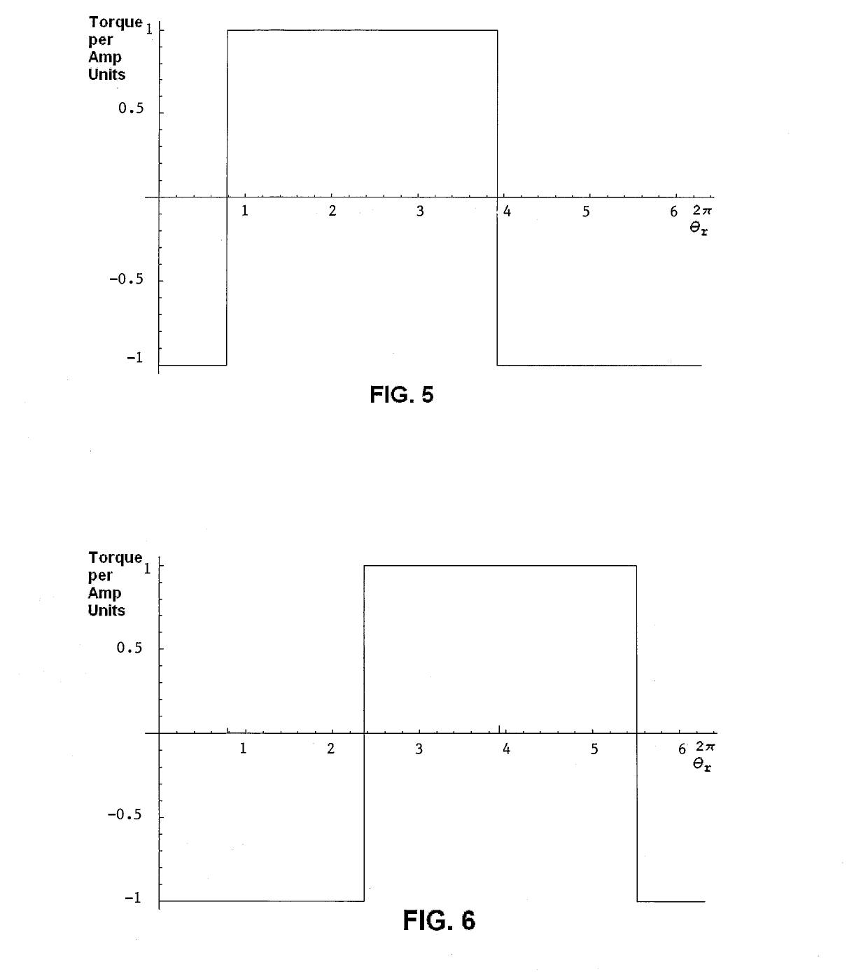

FIG. 5 is a graph of the torque per amp versus rotor angle, θₓ, for one revolution of the tandem rotor 11 for B phase. Note with two magnetic poles the torque per amp goes through one revolution for a full 360 degrees to produce an approximate square wave torque per amp output as shown in FIG. 5.

FIG. 6 is a graph of the torque per amp versus rotor angle, θₓ, for one revolution of the tandem rotor 11 for D phase. Note with two magnetic poles the torque per amp goes through one revolution for a full 360 degrees to produce an approximate square wave torque per amp output as shown. Note D phase lags B phase by 90 degrees for the direction of θₓ as shown in FIG. 6. Also note B phase lags A phase by 45 degrees and C phase lags B phase by 45 degrees

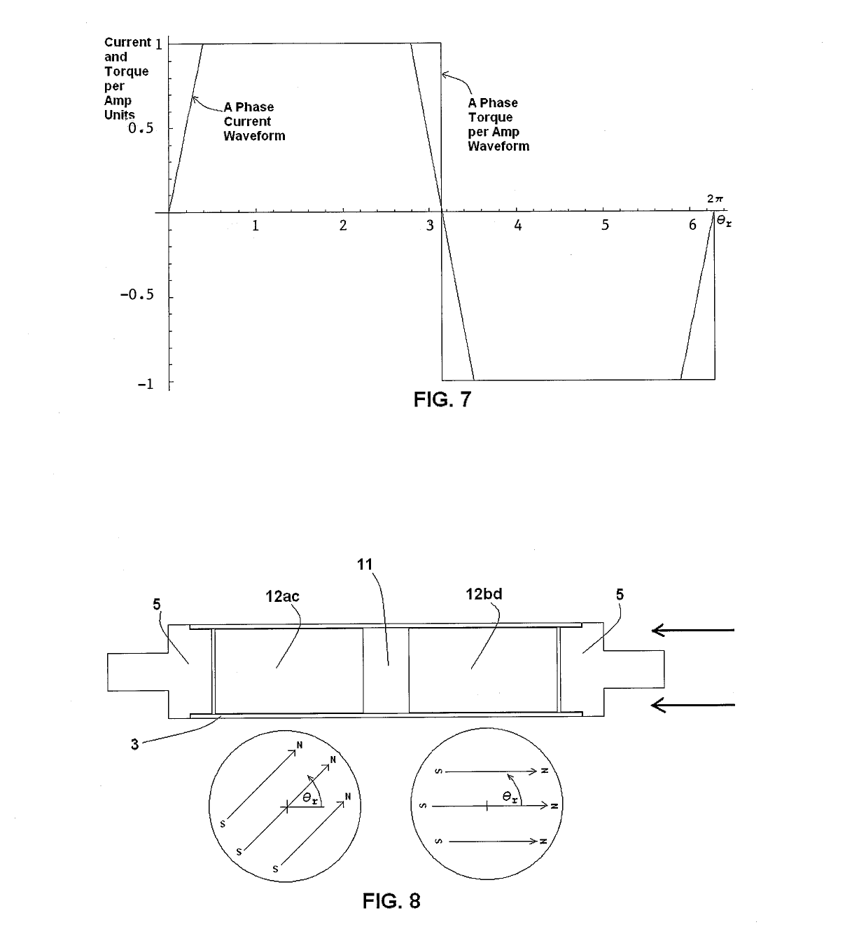

FIG. 7 shows the A phase current waveform in relation to the A phase torque per amp waveform. When the 4 phase drive provides currents that are in phase with the torque per amp for each phase as shown by the graph for the A phase in FIG. 7, the total torque of all 4 phases will result in a smooth ripple free torque. The torque per amp square waveform is an ideal waveform. Practically the torque per amp waveform will be rounded a bit and can be rounded purposely to a desired shape by shaping the magnet profile. This rounding will result in a slight torque ripple with the current waveform shown. However, the shape of the current waveform will always have a solution that a smooth ripple free total torque can be obtained.

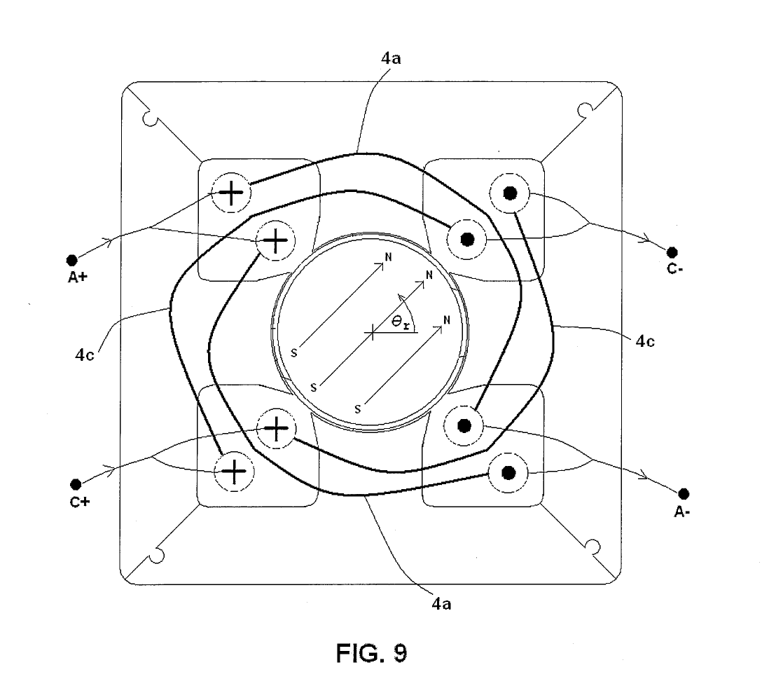

FIG. 8 is the tandem rotor 11. A rod shaped permanent magnet 12ac with a north pole and south pole and rod shaped permanent magnet 12bd with a north pole and south pole is mounted in rotor tube or sleeve 3 as shown in FIG. 8. Note rod permanent magnet 12bd lags rod permanent magnet 12ac by 45 degrees as shown by the magnetization directions as viewed from the end with arrows. The magnetized rods are inserted with the 45 degree magnetization and held by some means to rotor tube or sleeve 3. End shafts 5 are inserted and fixed to complete the rotor assembly.

FIG. 9 shows a structure or formation of placing the end turns 13 for element 1. The A phase coils and end turns are made up of 2 parallel coils 4a. The C phase coils and end turns are made up of 2 parallel coils 4c. The same structure or formation of placing the end turns 14 for element 2 are made similarly.

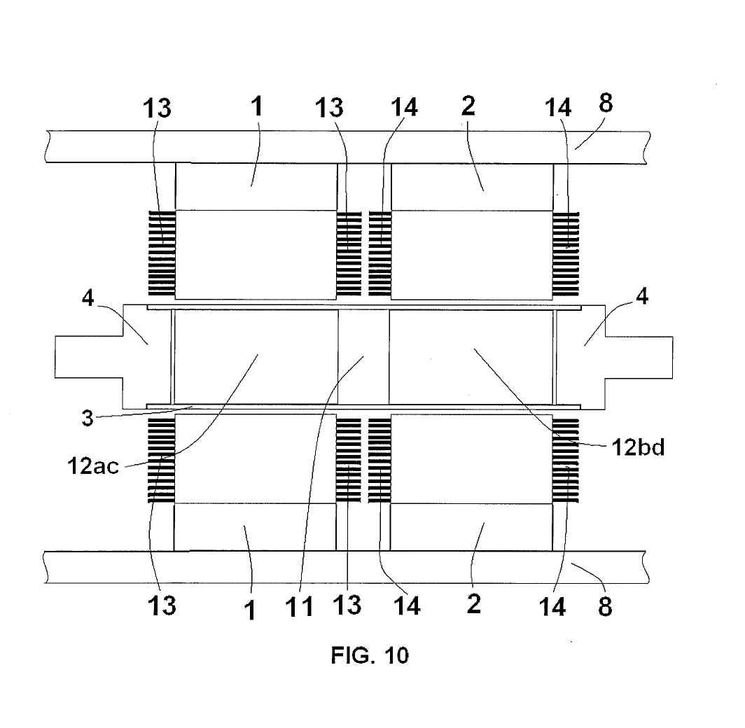

FIG. 10 shows the 2 tandem motor elements 1 and 2. The 2 tandem motor elements are held with a square tube 8 holding the tandem stator elements in place. The winding end turns 13 are as shown being A phase and C phase of element 1 and rod magnet 12ac within element 1. The winding end turns 14 are as shown being B phase and D phase of element 2 and rod magnet 12bd within element 2.

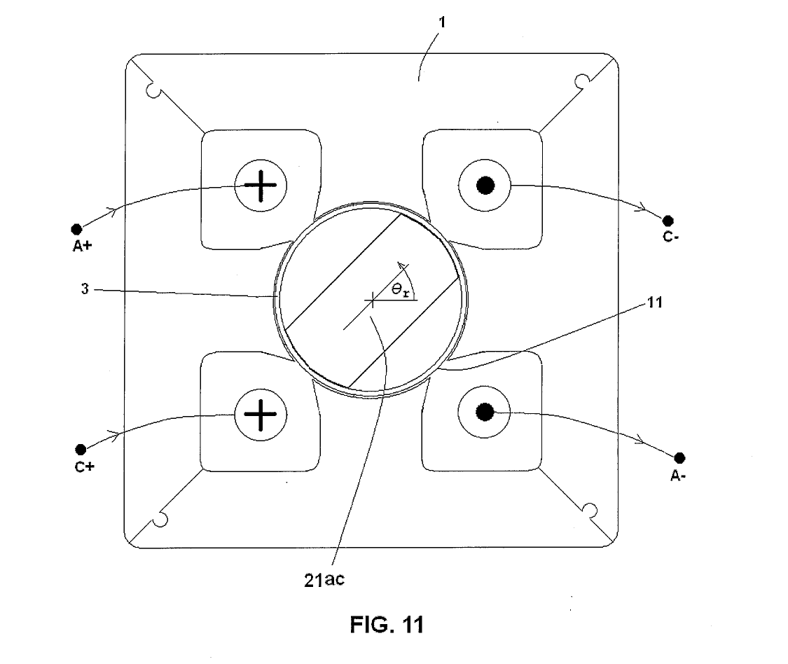

FIG. 11 shows the A phase and C phase tandem motor element 1 of a 4 phase motor. This element contains the tandem rotor 11. A reluctance rod 21 ac is mounted in rotor tube or sleeve 3. The square stator lamination stack holds the 2 windings. The windings are each two poles with terminal leads marked A+ and A− and C+ and C− with current indicating direction arrows on the leads of the phases.

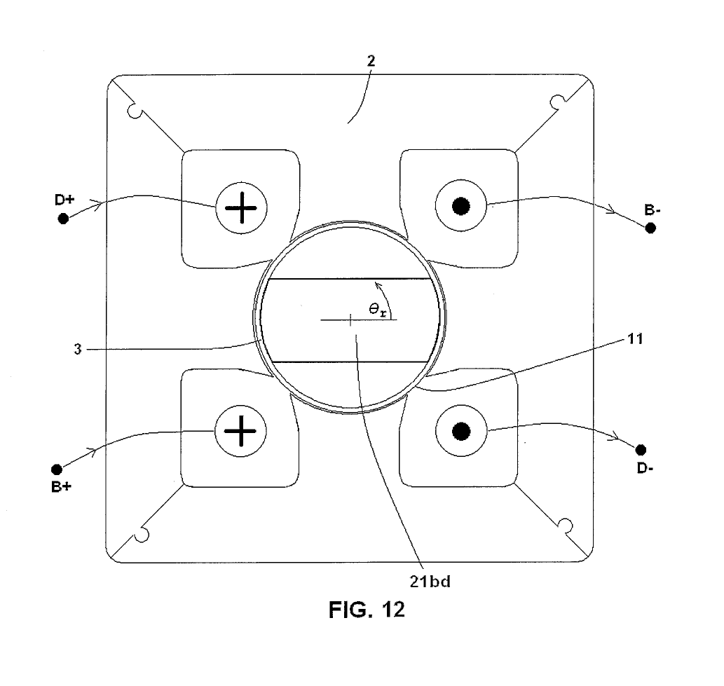

FIG. 12 shows the B phase and D phase tandem motor element 2 of a 4 phase motor. This element contains the tandem rotor 11. A reluctance rod 21bd is mounted in rotor tube or sleeve 3. The square stator lamination stack holds the 2 windings. The windings are each two poles with terminal leads marked B+ and B− and D+ and D− with current indicating direction arrows on the leads of the phases.

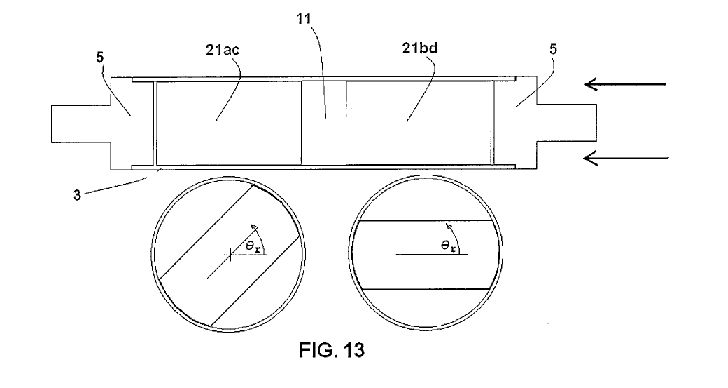

FIG. 13 is a tandem rotor 11 with reluctance rods. Note reluctance rod 21bd lags reluctance rod 21ac by 45 degrees as shown. The reluctance rods are inserted with the 45 degree displacement and held by some means to rotor tube or sleeve 3. End shafts 5 are inserted and fixed to complete the rotor assembly.

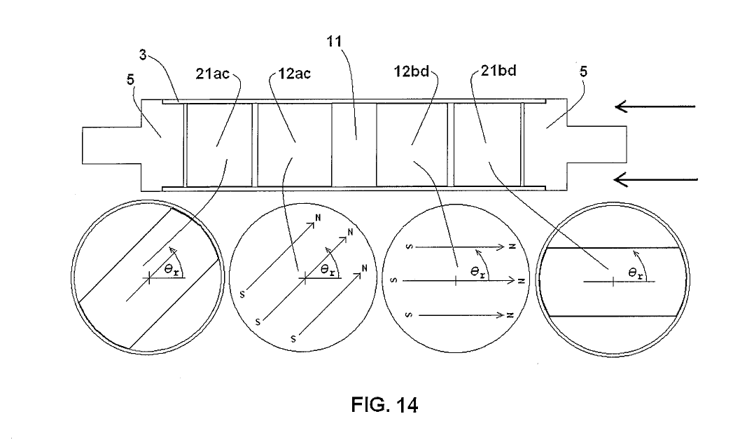

FIG. 14 is a tandem rotor 11 with one combination of reluctance rods and permanent magnet rods.

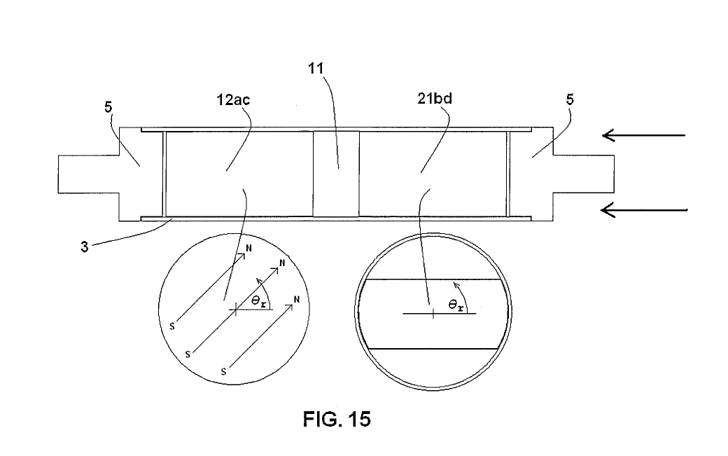

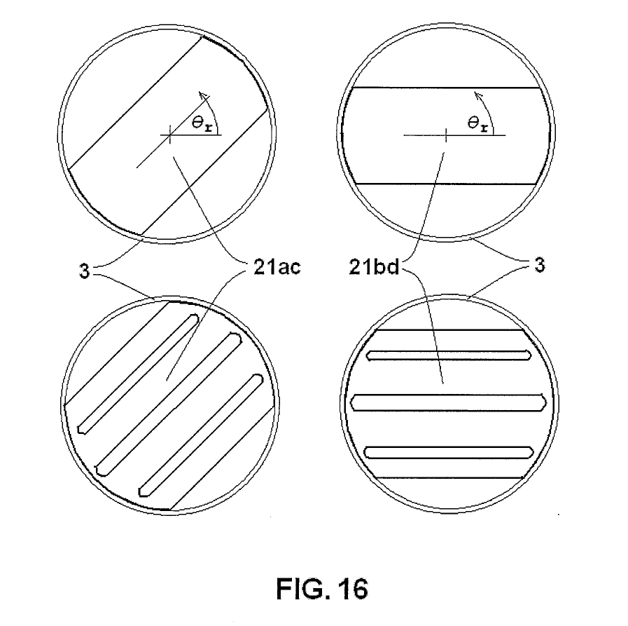

FIG. 15 is a tandem rotor 11 with another combination of reluctance rods and permanent magnet rods.

FIG. 16 shows reluctance rods. To get high reluctance in the torque axis slots are made for a higher reluctance. The magnetizing axis has lower reluctance to provide easy magnetizing and facilitate energy storage in that axis. The reluctance rods would normally be made of laminated material that is easily magnetized.

### SUMMARY TO BEST IMPLEMENT THE INVENTION

Make the 4 phase motor into tandem motor elements as described in FIG. 1 through FIG. 16. The 4 phase torque per amp waveform and current waveform of FIG. 7 is preferred along with the slight modifications described to get a ripple free total torque.

Make the 4 phase tandem motor stator elements a square shape as shown in FIG. 1, and FIG. 4. This provides a large slot area for the winding conductors which results in less heat for a given torque value. This again allows for a higher torque value which also increases the torque to inertia ratio.

Make the 4 phase tandem motor stator elements of segmented technology as shown in FIG. 1 and FIG. 4. Segmented stator technology allows a better fill factor of the amount of conductor volume one can get in the slot and motor. Having a higher conductor volume reduces the heat generated in the winding conductors for a given torque. Therefore a higher torque value can be achieved and again increases the torque to inertia ratio.

Make the 4 phase tandem motor rotor of low inertia structure as in FIG. 8, FIG. 13, FIG. 14, and FIG. 15. The tandem stators have the ability to drive the magnets with a very large force. So the magnets can be mounted at a small radius and still produce a high torque value. The ability of the stator to drive the magnets with a very large force greatly increases the torque to inertia ratio.

Make the 4 phase tandem motor reluctance rotors of FIG. 13, FIG. 14, and FIG. 15 to utilize energy storage for fast transients.

Make the 4 phase tandem motor permanent magnet stators of FIG. 8 with extra inductance to utilize energy storage for fast transients.

Make the 4 phase tandem servo motors with energy storage capability for applications with single step transients or multiple cycle transients. The energy storage may be sufficient to accelerate the motor and load to speed without having to take energy from the battery or capacitor bank. This can allow less capacitor expense since energy is not being transferred from the capacitor bank. Also reliability may be increased as thermal heat is otherwise generated in the resistance of the capacitors or batteries.

In carrying out the above best implementation of the invention one can expect a significant gain over commercial off-the-shelf servo motors designed for low inertia.

The embodiments of the invention in which an exclusive property or privilege is claimed are defined as follows:

1. A rotary actuator comprising:
a tandem rotor;
a first magnetic element disposed inside of the tandem rotor;
a second magnetic element disposed inside of the tandem rotor adjacent to the first magnetic element; and
a tandem stator wherein the tandem stator surrounds the tandem rotor.
